(19) United States
(12) Patent Application Publication
(10) Pub. No.: US 2026/0278684 A1
(43) Pub. Date: Sep. 17, 2026

(54) Autonomous Data Story and Graphical User Interface Element Generation

(71) Applicants: Harmeet GOINDI, Chicago, IL (US); Ankit VADHER, Chicago, IL (US); Cboe Exchange, Inc., Chicago, IL (US)

(72) Inventors: Harmeet Goindi, Tuckahoe, NY (US); Ankit Vadher, Chicago, IL (US)

(21) Appl. No.: 19/472,748

(22) PCT Filed: Apr. 8, 2024
(86) PCT No.: PCT/US2024/023574

§ 371 Date: Oct. 6, 2025

Related U.S. Application Data
(60) Provisional application No. 63/494,942, filed on Apr. 7, 2023.

(51) Int. Cl. G06Q 40/04; G06F 9/451; G06F 40/186

(52) U.S. Cl. CPC G06Q 40/0431; G06F 9/451; G06F 40/186

(57) ABSTRACT

Automated synthesis of natural-language reports can be created from raw data. Operations can include storing, in an alert-datastore, a plurality of rulesets; receiving a stream of data objects; determining that at least one given data objects satisfies the one or more tests of at least one given ruleset and responsively: generating a corresponding alert that includes information derived from the given data object; generating a graphic user interface (GUI) report that comprises a graphical depiction of the information derived from the given data object; generating a narrative object using the information derived from the given data object, the narrative object comprising human-readable text, the generating being performed by automated operation of the computer system without specific input from a user; and adding, to a newsfeed stream, a new newsfeed object that comprises the GUI report and also comprises the narrative object; and serving the newsfeed stream.

### CROSS-REFERENCE TO RELATED APPLICATION

This application claims the benefit of U.S. Provisional Patent Application No. 63/494,942, filed Apr. 7, 2023, which is incorporated herein by reference in its entirety.

### BACKGROUND

High volumes of financial instruments such as derivatives, stocks, and bonds are continuously traded at electronic exchanges, which enable trades to occur in real time through the algorithmic processing of orders and associated market information. Generally, a trade may be executed when the price associated with a bid to purchase a financial instrument matches the price associated with an offer to sell the same instrument. Market participants typically price their bids and offers based on market conditions, which are subject to rapid change, and electronic exchanges often match bids and offers based on price-time priority, and the principle of first-in, first-out (FIFO).

### SUMMARY

In an electronic or hybrid exchange environment, thousands of transactions are executed each second, and unforeseen events occur frequently. Many market participants rely on intelligence derived from market data to inform their decisions and actions, but individual participants lack the technological means to continuously monitor the vast amount of data generated each second through trading activity. An exchange computer system with sufficient bandwidth and processing resources can, however, translate the data flowing through it and available from other networked sources into actionable intelligence that connected users can rely upon. For example, due to the speed of transactions and the volume of data they create, users are at risk of taking a market position as a result of outdated information. This can discourage users from participating in electronic exchanges due to information disadvantages, particularly if the are not using real-time information.

This document provides solutions for this problem. For example, and as described in this disclosure, an exchange computer system can be configured to generate a human-readable report in a graphical user interface (GUI) based on select important (e.g., user-relevant or impactful) details from market data, and present the market data in a narrative format next to graphical elements (e.g., timeseries graphs, bar charts). The system can display the data related to the information in a graphical and narrative format that is easily understood and customized for a user. With this technology, a computer system can identify important data, and present the data with two modalities designed to be easier to digest than a simple presentation of the data alone. The use of automated data analysis tools can allow for more, faster, and objective analysis of the market data, while coupling the data with friendly user text to help orient the user to the story or narrative available in the data.

Because of the volume and speed at which market data is often generated, the system can and does work to analyze pertinent information faster than a human or group of human analysts could work to identify the features of the data worth understanding. This can allow for “real-time” generation of the these reports.

But reports generated rapidly can be difficult to understand and appreciate for a user, especially if there is not another human that generates the report to talk to. In this technology, this technological limitation (difficulty in understanding narratives created by a non-human actor) can be overcome with a technological feature (human-readable, friendly summaries of the narrative to see in the data). As will be explained later, various natural-language processes can be used to supply this friendly summary. These natural language processes can turn the raw data into human-readable language using computational techniques that are different than those employed by humans discussing the same information. For example, instead of applying personal observations (possibly with personal biases and preconceived notions), the natural language processes can create consistent, objective narratives, and identify tends and patterns in data. In some cases, narrative summaries can be created by projective vectors of data into a language space, which is an operation performed by computers but not done by humans when generating narratives. In some cases, narrative summaries can be generated by providing a list of details to a computer-implemented large language model, which is a computer system that uses machine learning (and not human behavior) to generate a report that accurately turns the list of details into a narrative, using patterns and formats found in large training corpuses of text to create new, but familiar, narrative formats. As will be appreciated, the large language models do more than just mimicking human speech or literature, they perform specific loss-minimizing functions across various parameters to produce results that no human has predefined or could predict.

As described in more detail within this application, an exchange computer system can be implemented to dynamically, efficiently, and continuously generate a stream of reports based on streams of input data, allowing for the generation of the newsfeed (or other stream of output data) as new input data becomes available. Due to the arrangement and types of technologies used, this newsfeed can contain reports that are in “real-time,” being generated within tenths of a second, seconds, or tens of seconds of the input data being created. In this way, a user can have accesses to reports created on the freshest data. Then, as the underlying data changes, the reports themselves can change. For example, a newsfeed item can include a report (with data visualization and human-readable text) related to a recent market event (e.g., an announcement of a stock buy-back plan). If the user reads the report right away, they will have up-to-date information in the report. But if the user reads the report seconds, minutes, or hours later, the system can continuously update the report as new market information becomes available. Sometimes, this market data is different enough to change the take-aways from the data. In such a case, not only does the data visualization update in the report, the narrative story with the report can change. In the example of the stock buy-back plan, the report may initially contain data showing a sharp price drop. In such an event, the narrative may include language indicating the buy-back plan resulting in a price drop. But within a few minutes, the market participants may begin buying the stock, raising the price and volume traded. Then, instead of maintaining the now stale report of the price drop, the newsfeed report can dynamically change to show the increased price and volume. Concurrently, the narrative may be updated as well, changing from a ‘stock price drops after buy-back plan announced’ type of message to a ‘buy-back plan leads to increased price, volume’ type of message.

This technology can allow a user to define objective rules for alerts to be generated, allowing the technology to create user-defined news streams tailored to the user's interests and concerns. For example, a user (or their organization, etc.) can define rules for when a trade or event meeting the user's criteria. By producing a newsfeed that only includes the alerts that match the user's criteria, the technology can produce newsfeeds that only contain report that the user expects to be of interest. This can allow the user to more efficiently access relevant reports, because the user will not need to sift through default or generally-applicable reports that are of low or no interest to the particular user.

Templates for a given narrative can be created to contain all information needed for a given narrative. By organizing the temples to be self-contained, the system can select any appropriate template and us it without needing to add in other templates or other information. This self-contained nature provides a number of advantages. For example, when more than one template is applicable to a given alert, the template that is actually used for the report can be randomly selected, selected on a rotating basis, etc. This can allow for sequential reports in a newsfeed to have different narrative structure, even when the report is triggered by the same alert rule. This variety and unpredictability can increase interest and memorability of sequential reports, providing a user with novel stimulus to potentially otherwise-similar reports.

Data visualizations related to a narrative can be presented in a single graphic user interface (GUI) for a user. By presenting all the information in a single GUI, without requiring the user to scroll, navigate, or search away from the narrative, the technology can present the information in a more efficient way than other technologies that are unable to provide all relevant information at a glance.

In addition, the GUI can also have relevant navigation tools to find other data that is related to the narrative. This can allow the reader to quickly pivot from the information in the narrative to other related information that they may be interested in based on the report.

In some aspects, the techniques described herein relate to a system to provide natural-language reports from raw data, the system including: a computer system including at least one processor and memory, the computer system configured to perform operations including: storing, in an alert-datastore, a plurality of rulesets that each define one or more tests that, when met by a data object, cause an alert to be generated; receiving a stream of data objects that each record information of an event; determining that at least one given data objects satisfies the one or more tests of at least one given ruleset and responsively: generating a corresponding alert that includes information derived from the given data object; generating a graphic user interface (GUI) report that includes a graphical depiction of the information derived from the given data object; generating a narrative object using the information derived from the given data object, the narrative object including human-readable text, the generating being performed by automated operation of the computer system without specific input from a user; and adding, to a newsfeed stream, a new newsfeed object that includes the GUI report and also includes the narrative object; and serving the newsfeed stream including providing the new newsfeed object in a sequential position with other newsfeed objects of the newsfeed stream.

In some aspects, the techniques described herein relate to a system, wherein the operations further include: performing exchange operations, including: executing trades; and generating, using the executing trades, the stream of data objects, wherein each data object records information of at least one of the executing trades.

In some aspects, the techniques described herein relate to a system, wherein generating the narrative object using the information derived from the given data object includes randomly selecting a selected template from a plurality of possible templates, and to populate the selected template with the information derived from the given data object.

In some aspects, the techniques described herein relate to a system, wherein generating the narrative object using the information derived from the given data object includes procedurally selecting a selected template from a plurality of possible templates based on a record of previously-accessed possible templates, and to populate the selected template with the information derived from the given data object.

In some aspects, the techniques described herein relate to a system, wherein generating the narrative object using the information derived from the given data object includes: generating a vector using the information derived from the given data object; providing the vector to a large language model; and receiving from the large language model the human-readable text.

In some aspects, the techniques described herein relate to a system, wherein generating the narrative object using the information derived from the given data object includes validating the human-readable text to verify that the generation of the human-readable text by the large language model did not introduce errors in the human-readable text.

In some aspects, the techniques described herein relate to a system, wherein generating the narrative object using the information derived from the given data object includes modifying the human-readable text with the large language model to modify the human-readable text while maintaining the information derived from the given data object in the human-readable text.

In some aspects, the techniques described herein relate to a system, wherein generating the narrative object using the information includes: populating a selected template with the information derived from the given data object; and modifying the human-readable text with a large language model to modify the human-readable text while maintaining the information derived from the given data object in the human-readable text.

In some aspects, the techniques described herein relate to a system, wherein the operations further include rendering the new newsfeed object such that i) the GUI report and ii) the narrative object are both displayed to a user concurrently.

In some aspects, the techniques described herein relate to a system, wherein rendering the new newsfeed object includes dynamically generating a number of data-windows based on a count of a number of types of the information derived from the given data object such that each type is rendered in a single data-window concurrently.

In some aspects, the techniques described herein relate to a system, wherein rendering the new newsfeed object includes rendering an interface element that, when interacted with by a user, causes the rendered newsfeed to change a graphical depiction of the information while concurrently displaying the narrative object.

In some aspects, the techniques described herein relate to a method of providing of natural-language reports from raw data, the method including: a computer system including at least one processor and memory, the computer system configured to perform operations including: storing, in an alert-datastore, a plurality of rulesets that each define one or more tests that, when met by a data object, cause an alert to be generated; receiving a stream of data objects that each record information of an event; determining that at least one given data objects satisfies the one or more tests of at least one given ruleset and responsively: generating a corresponding alert that includes information derived from the given data object; generating a graphic user interface (GUI) report that includes a graphical depiction of the information derived from the given data object; generating a narrative object using the information derived from the given data object, the narrative object including human-readable text, the generating being performed by automated operation without specific input from a user; and adding, to a newsfeed stream, a new newsfeed object that includes the GUI report and also includes the narrative object; and serving the newsfeed stream including providing the new newsfeed object in a sequential position with other newsfeed objects of the newsfeed stream.

In some aspects, the techniques described herein relate to a method, wherein generating the narrative object using the information derived from the given data object includes randomly selecting a selected template from a plurality of possible templates, and to populate the selected template with the information derived from the given data object.

In some aspects, the techniques described herein relate to a method, wherein generating the narrative object using the information derived from the given data object includes procedurally selecting a selected template from a plurality of possible templates based on a record of previously-accessed possible templates, and to populate the selected template with the information derived from the given data object.

In some aspects, the techniques described herein relate to a method, wherein generating the narrative object using the information derived from the given data object includes: generating a vector using the information derived from the given data object; providing the vector to a large language model; and receiving from the large language model the human-readable text.

In some aspects, the techniques described herein relate to a method, wherein generating the narrative object using the information derived from the given data object includes validating the human-readable text to verify that the generation of the human-readable text by the large language model did not introduce errors in the human-readable text.

In some aspects, the techniques described herein relate to a method, wherein the operations further include rendering the new newsfeed object such that i) the GUI report and ii) the narrative object are both displayed to a user concurrently.

In some aspects, the techniques described herein relate to a method, wherein rendering the new newsfeed object includes dynamically generating a number of data-windows based on a count of a number of types of the information derived from the given data object such that each type is rendered in a single data-window concurrently.

In some aspects, the techniques described herein relate to a method, wherein rendering the new newsfeed object includes rendering an interface element that, when interacted with by a user, causes the rendered newsfeed to change a graphical depiction of the information while concurrently displaying the narrative object.

In some aspects, the techniques described herein relate to a non-transitory computer-readable medium storing instructions that, when executed by one or more processors, cause the one or more processors to perform operations including: storing, in an alert-datastore, a plurality of rulesets that each define one or more tests that, when met by a data object, cause an alert to be generated; receiving a stream of data objects that each record information of an event; determining that at least one given data objects satisfies the one or more tests of at least one given ruleset and responsively: generating a corresponding alert that includes information derived from the given data object; generating a graphic user interface (GUI) report that includes a graphical depiction of the information derived from the given data object; generating a narrative object using the information derived from the given data object, the narrative object including human-readable text, the generating being performed by automated operation without specific input from a user; and adding, to a newsfeed stream, a new newsfeed object that includes the GUI report and also includes the narrative object; and serving the newsfeed stream including providing the new newsfeed object in a sequential position with other newsfeed objects of the newsfeed stream.

The details of one or more embodiments of the subject matter described in this specification are set forth in the accompanying drawings and the description below. Other potential aspects, features, and advantages will be apparent from the description, the drawings, and the claims.

### BRIEF DESCRIPTION OF THE DRAWINGS

FIG. 1 is an example diagram of an exchange computer system and associated networks, devices, and users.

FIG. 2 is an example diagram of an exchange computer system including a report engine.

FIG. 3 is an example graphic user interface (GUI) to show a report.

FIG. 4 is an example process for generating natural-language reports from raw data.

FIG. 5 is example processes and data for generating human-readable text.

FIG. 6 is an computing device for an exchange computer system.

### DETAILED DESCRIPTION

This disclosure describes technology for generating a data-rich graphic user interface (GUI) that contains both a graphic representation of market data, and a computer-generated, human-readable narrative created from the data. Story templates can be written in a format to include an display data elements (e.g., market flow analytics) in real-time when specific market conditions are triggered. The templates can be self-contained such that all the data needed for their story can be called within a single template. This self-contained nature provides for efficient and effective generation of useful narrative reports. The templates can be applied to equities and options for the equities. They can also be applied to other asset classes such as digital currencies, cryptocurrencies, futures, foreign exchange markets, etc. These templates can be used for global market coverage, providing for universal analysis. Thus, with this technology, a user can be provided with information that would otherwise require sifting through thousands of data point to uncover a useable dataset.

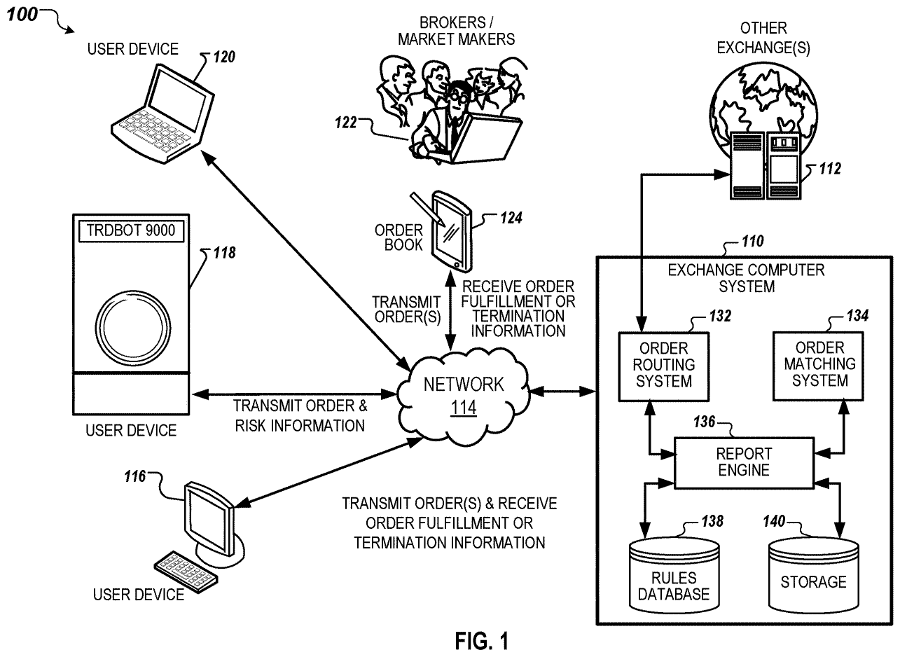

FIG. 1 is a diagram of an exemplary trading environment 100 for cration of natural-language reports from raw data. The trading environment 100 can include an exchange computer system and the associated networks, devices, and users. Generally, the term “user” may refer to any entity that interacts with the exchange computer system and/or associated networks and devices. Users can include, for example, market makers and other market professionals, brokers, institutional traders, individual traders, and automated trading systems. The diagram includes an exchange computer system 110, other exchanges 112, a network 114, user devices 116, 118, 120, market makers/brokers 122, and electronic order book 124.

The exchange computer system 110 can be implemented in a fully electronic manner, or in a hybrid manner that combines electronic trading with aspects of traditional open-outcry systems. The exchange computer system 110 can receive orders for trading financial instruments locally on the floor and from remote electronic devices. The financial instruments can include securities such as stocks, options, futures contracts, or other derivatives associated with an underlying asset.

Network 114 connects the various components within the trading environment, and can be configured to facilitate communications between those components. Network 114 can, for example, be configured to enable the exchange of electronic communications that include order and order fulfillment information between connected devices, such as an electronic order book 124 and the exchange computer system 110.

Network 114 can include one or more networks or subnetworks, each of which can include a wired or wireless data pathway. Network 114 can, for example, include one or more of the Internet, Wide Area Networks (WANs), Local Area Networks (LANs), or other packet-switched or circuit-switched data networks that are capable of carrying electronic communications (e.g., data or voice communications).

To protect communications between the various systems, devices, and components connected to network 114, network 114 can implement security protocols and measures such that data identifying order or bid information, or parties placing orders or quotes, can be securely transmitted. Network 114 can, for example, include virtual private networks (VPNs) or other networks that enable secure connections to be established with exchange computer system 110.

User devices 116, 118, and 120 can include portable or stationary electronic devices, such as smartphones, laptops, desktops, and servers that include user interfaces to display information and receive user input, and that are configured to communicate over a computer network. User devices 116, 118, and 120 can communicate with the exchange computer system 110 over network 114 using a proprietary protocol, or a message-based protocol such as financial information exchange (FIX), implemented over TCP/IP.

User devices 116, 118, and 120 can transmit user input such as order information or risk information to the exchange computer system 110, and can also receive data from the exchange computer system 110 indicating that an order has been filled or canceled.

Users such as brokers/market makers 122 can also place orders and receive information about order fulfillment or termination through electronic order book 124, which can include a record of outstanding public customer limit orders that can be matched against future incoming orders.

The exchange computer system 110 includes an order routing system (ORS) 132, an order matching system (OMS) 134, an report engine 136, a database of trading rules and algorithms 138, and storage 140. In some implementations, the exchange computer system 110 is a distributed computer system.

The order routing system (ORS) 132 determines whether a received order or quote is to be executed at the exchange computer system 110, or should instead be redirected to another exchange 112, and can include processing systems that enable the management of high data volumes. The ORS 132 can, for example, receive order or quote information for the purchase or sale of financial instruments from one or more user devices 116, 118, 120, and 124. In some implementations, the ORS 132 can also be connected to or include a touch-screen order routing and execution system accessible by brokers on the exchange floor, such as a public automated routing (PAR) system.

Upon receiving an order or quote, the ORS 132 determines if the destination specified in the received order or quote is the exchange computer system 110. If the exchange computer system 110 is not the destination, the ORS 132 forwards the order or quote to another exchange 112, which can be either the destination exchange, or an exchange en route to the destination exchange.

If the ORS 132 determines that the exchange computer system 110 is the destination of the received order or quote, the ORS 132 can forward the received order or quote to the order matching system 134.

The order matching system (OMS) 134 can include processing systems that analyze and manipulate orders according to matching rules stored in the database 138. The OMS 134 can also include an electronic book (EBOOK) of orders and quotes with which incoming orders to buy or sell are matched, according to the matching rules. The EBOOK can also be implemented in a separate database such as storage 140, which can include multiple mass storage memory devices for the storage of order and quote information. When the OMS 134 determines that a match exists for an order (for example, when a bid matches an offer for sale), the order matching system 134 can mark the matched order or quote with a broker-specific identifier so that the broker sending the order or quote information can be identified.

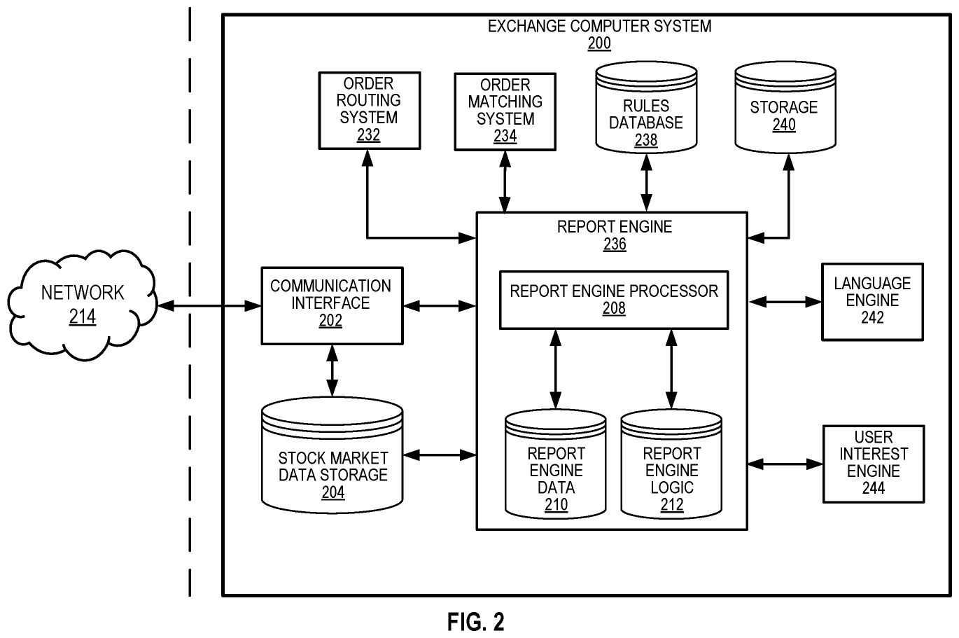

The report engine 136 can be implemented using a combination of software and hardware. The report engine 136 can, for example, be implemented as one or more hardware processors configured to execute one or more algorithms, as described in further detail below. An example configuration of an exchange computer system featuring an report engine 136 is further described in FIG. 2.

The report engine 136 can automatically generate news and “color commentary” such as easy to read graphics and text about trades and other operations of the trading environment. For example, the report engine 136 can monitor activities of the exchange computer system 110, the other exchanges 112, and other data sources to collect data of operations and events. Then, when an event occurs that matches one or more rules (e.g., stored in the rules database 138), the report engine 136 can generate a newsfeed item related to that event. The report engine 136 can then publish the newsfeed item to one or more newsfeeds. User devices 116, 118, and 120 etc. can subscribe to one or more of these newsfeeds to receive updates from the report engine 136.

In some implementations, the exchange computer system 110 is a distributed computer system that includes an order entry port (e.g., by network 114), an order routing system (e.g., ORS 132), an order matching system (e.g., OMS 134), and a report engine (e.g., report engine 136). The distributed computer system can operate multiple hardware and software processes in parallel configurations. The order entry port receives the order from the data sent to the exchange computer system by a user device and the order routing system is configure to route the order to a destination associated with the order. As an example, the destination can include other exchanges 112, based on matching rules stored on database 138 and the configuration of the order matching system to match the order to the destination in the other exchanges 112.

Storage 140 and database 138 store and handle data in a manner that satisfies the privacy and security requirements of the exchange computer system 110 and its users, and can store one or more of telemetric data, user profiles, user history, and rules and algorithms for matching quotes, bids, and orders.

Upon completion of a trade (through the floor in open outcry as entered into the PAR system, or through automatic execution through the OMS 134 and report engine 136), the fill information is passed through the OMS 134 and the ORS 132 to one or more user devices 116, 118, 120, and 124, and to the report engine 136. The exchange computer system 110 matches the buy side and sell side of a trade, and forwards the matched trade to a third party organization that verifies the proper clearance of the trade, such as the Options Clearing Corporation (OCC) where the securities may be options, or Depository Trust Company (DTC) where the securities may be equities. The OMS 134 also formats the quote and sale update information and sends that information through an internal distribution system that refreshes display screens on the floor, in addition to submitting the information to a quote and trade dissemination service such as, in the case of options, the Options Price Reporting Authority (OPRA).

FIG. 2 is a diagram of an example exchange computer system 200 including an report engine 236 configured to synthesize natural-language reports of raw data from exchange operations or other activities. The exchange computer system 200 can be implemented by software, hardware, or some combination as described herein. As an example, the exchange computer system 200 can be implemented as a server, a computer, or other device or processing component using proprietary software designed and implemented to achieve the functionality described herein. The exchange computer system 200 can be distributed or subdivided between a plurality of entities e.g., multiple computing devices.

The exchange computer system 200 can include a communication interface 202, coupled with a stock market data storage 204. The communication interface 202 can be communicatively linked to a report engine 236, which includes a report engine processor 208, report engine data 210, and report engine logic 212. The report engine 236 can also be communicatively linked to an ordering matching system 234, an order routing system 232, a rules database 238, storage 240, a language engine 242, and a user interest engine 244 of the exchange computer system 200. The communication links in the exchange computer system 200 can be established by a system bus, network, or one or more other connection mechanisms. As an example, the connection mechanisms can include a wired connection, a wireless connection, or a combination thereof. For example, the connection can be a physical connection, such as a wired Ethernet connection. In another example, the connection can be a wireless connection, such as a cellular telephone network, an 802.11, 802.16, 802.20 controls or components, a WiMax network, or any other type of network. Further, network 214 can be a public network, such as the Internet, a private network, such as an intranet, or combinations thereof, and can utilize a variety of networking protocols now available or later developed including, but not limited to TCP/IP based networking protocols.

The report engine processor 208 can include one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components now known or later developed. The report engine processor 208 can carry out one or more instructions using one or more arithmetic, logical, and/or input/output operations. Though report engine processor 208 is illustrated as a single component, report engine processor 208 can be integrated in whole or in part with other components of the exchange computer system 200.

Data storage e.g., stock market data storage 204 and report engine data 210, may be a main memory, a static memory, or a dynamic memory. Stock market data storage 204 and storage for report engine data 210 can include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, organic storage components, and the like. As an example, the stock market data storage 204 and storage for report engine data 210 can include a cache or random access memory for the report engine processor 208. Stock market data storage 204 and storage for report engine data 210 can be separate from the report engine processor 208, such as a cache memory of a processor, the system memory, or other memory. Stock market data storage 204 and storage for report engine data 210 can be an external storage device or database for storing data. Examples can include a hard drive, compact disc (“CD”), digital video disc (“DVD”), memory card, memory stick, universal serial bus (“USB”) memory device, or any other device operative to store data.

As further shown, the report engine 236 can include report engine data 210 and/or report engine logic 212. The report engine data 210 can include one or more types of data suitable for a given implementation. For example, report engine data 210 can include data (such as input datasets) that can be stored in memory. Report engine logic 212 can include, for example, machine language instructions executable by report engine 236 to carry out various functions, such as the functionality of the methods and systems described herein. In some implementations, the functions, acts or tasks can be independent of the particular type of instructions sets, storage media, processor or processing strategy and can be performed by software, hardware, integrated circuits, firm-ware, micro-code and the like, operating alone or in combination. Processing strategies can include multiprocessing, multitasking, parallel processing and the like.

The report engine 236 is an example of the report engine 136 described in reference to FIG. 1 above. The report engine 236 can be configured to access data in the stock market data storage 204 and receive data from the network 214, as well as data from the report engine data 210. When one or more rules, stored for example in the rules database 238, match events identified by the report engine 236, the report engine can assemble a report about the event or the events.

The report can include raw data, which can include data from events that is unchanged or minimally changed. For example, the price of a recent transaction can be included in the raw data, and/or an aggregation (average, median, distribution, etc.) can be include in the raw data. The report engine 236 can use a language engine 242 to create human-readable text to go along with the raw data. As shown here, the language engine 242 is implemented as a component of the exchange computer system 200, but other alternatives are possible. For example, the language engine can be provided as a network service, accessible via the network 214.

A user interest engine 244 can generate and update user interests related to market conditions or other news. For example, each user eligible to receive a report from the report engine 236 can have a corresponding account in the user interest engine 244. The account can have associated with it one or more interests, rules, or details about the user that he report engine 236 an use to create the templates and or rulesets for generating reports. In some cases, the user can directly identify their interests. For example, a user can provide a list of their interests, provide a list of market instruments owned, etc. In some cases, the user interest engine 244 can use machine learning to identify interests for a user. For example, the user interest engine can use a classifier that receives, as input, information about the user and provide, as output, a list of interests for the user. The classifier may include a model trained on training data of users that has details about the users and corresponding interests for the user.

In the exchange computer system 200, the communication interface 202 can include one or more structures, and associated equipment, for receiving data from one or more sources and distributing data to a group of one or more destinations. In some implementations, the communication interface 202 can include one or more additional communication interfaces and can operate in different configurations (e.g., distributed system, parallel). The communication interface 202 can be configured to receive input datasets from one or more entities (e.g., user devices or other exchanges) and store all or part of the input datasets in stock market data storage 204. The communication interface 202 can also be configured to communicate all or part of the input datasets to the report engine 236 once the input datasets are stored or otherwise processed. The communication interface 202 can include a transceiver having one or more input/output ports connected to the network 214 to securely transmit implied movement data from the report engine 236 to user computing devices.

As an example, the input datasets are stored in stock market data storage 204 can be partitioned (e.g., horizontal, vertical, functional) into designated memory locations (e.g., virtual addresses) based on qualities of the input datasets, e.g., a type of stock market index, a type of stock market index option, a type of stock option, and a type of stock. In some implementations, the input datasets with data related to component stock options can be stored in stock market data storage 204 and include a linking identifier (e.g., address, memory mapping) to identify a corresponding stock for each of the component stock options. In some implementations, the stock market data storage 204 can be configured to receive an indicator describing the operating status (e.g., receiving, clearing, storing) input datasets of the communication interface 202.

The input datasets from the communication interface 202 can include financial market data (e.g., market intelligence) corresponding to a stock market index (e.g., Standard and Poor's 500 Index) and the component stocks corresponding to the stock market index. For example, financial market data can include volatilities, interest rates, returns (e.g., historical, expected), market capitalization, sector, prices, liquidity, and other metrics related to the component stocks and stock market index. Financial market data can also include measures, estimates, and other related data for options (e.g., calls, puts), futures, and other derivatives for the stock market index and component stocks. The input datasets can also include corresponding log files to describe and store the financial market data e.g., a log file describing volatility for each component stock option. The log files can include metadata to tag or characterize data, e.g., corresponding time periods for which the data was recorded. For example, the log files can include a tag to be used for sorting or filtering the data of the log files.

Upon receiving input datasets from the communication interface 202, including data stored in the stock market data storage 204, the report engine 236 can perform further processes including receiving requests and accessing metadata. The report engine 236 can perform operations using the report engine processor 208, with instructions stored in the report engine logic 212, and data stored in report engine data 210. The data stored in report engine data 210 can include all of or a subset (e.g., filtered) of the data stored in stock market data storage 204, where the subset of the data stored in the report engine data 210 is filtered based on a specified time period. The report engine 236 can perform operations on the report engine data 210 including deleting, archiving, tagging, and resetting. The report engine 236 can utilize metadata, including log files, to process (e.g., filtering, sorting) the report engine data 210.

The report engine 236 can also access other components of the exchange computer system 200 including the order matching system 234, order routing system 232, rules database 238, and storage 240. The order matching system 234 can be configured to match an order received from the user device (e.g. user devices 116, 118, and 120) to another order based on the matching rules stored in the rules database 238. The order routing system 232 can be configured to route the order received from the user device to a destination associated with the order. The storage 240 can include additional data from the exchange computer system 200, accessed by the report engine 236 for processing.

An exchange computer system 110 of FIG. 1 or exchange computer system 200 of FIG. 2 that includes the report engine 236 can be configured to generate watch for and report on events in the system. For example, the report engine 236 can be configured (e.g. by report engine logic 212) to obtain data through the communication interface 202 such as data related to stocks for an underlying asset, data to the stock market index, and data related to stock options of the underlying asset. The report engine logic 212 configures the report engine 236 to process the data and perform the steps to generate a newsfeed item to be published in a newsfeed

In some implementations, the communication interface 202 can be expanded to include additional ports that are configured to provide dataflow to and from the report engine 236 of the exchange computer system 200. The expansion of data flow ports that are uniquely configured the memory for the report engine processor 208 can be expanded to process additional data. In some implementations, the report engine logic 212 can be further programmed to correlate data received, e.g., by the communication interface 202, and thus allow the exchange computer system to pre-allocate resources to determine and implied move index and implied move index value.

In some implementation, the exchange computer system 200 can be configured to generate a notification (e.g., an alert) based on the creation of a newsfeed item. For example, the report engine 236 can create a “push” type notification such as an email or text message to be sent to a receiver. In some example, the report engine 236 can additionally or alternatively generate a “publication” type notification, to which other elements can subscribe, such as a dynamically updating webpage, Real Simple Syndication (RSS) file, etc. The, the various subscribes can request and receive the file or files for the subscription as needed (e.g., in response to user requests, on a particular time schedule, as computing resources are available)

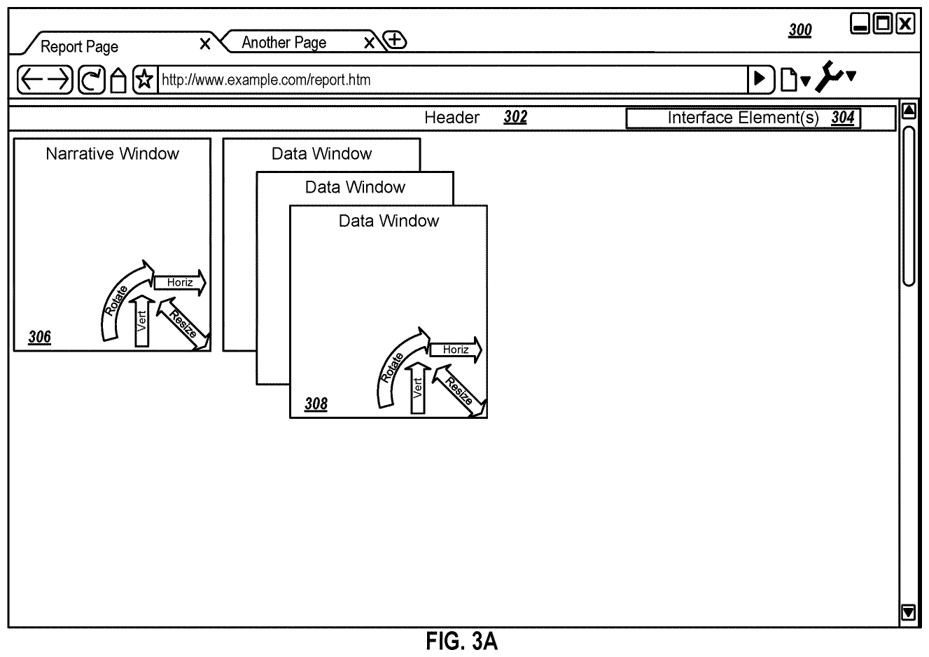

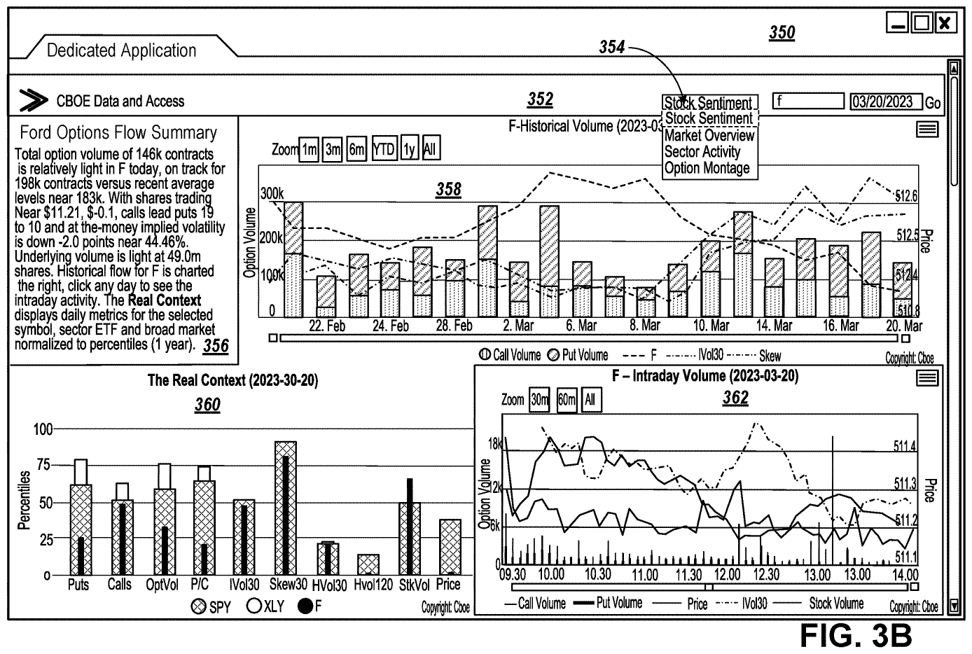

FIG. 3 is an example graphic user interface (GUI) to show a report. FIG. 3A shows an example of layout data rendered for view, and FIG. 3B shows an example GUI that has used this layout data to layout and render an actual GUI with example data. The GUI can provide a data rich display that provides users with a multitude of actionable datasets such as stock sentiment, options volume, sector analysis, implied volatility, corporate actions, and bullish/bearish stories.

An application such as a web browser 300 and/or a dedicated application 350 can lay out a GUI with various layout elements. A header 302 can be used to store a heading or title for the GUI. An example header 352 is shown.

Interface elements 304 can include various GUI elements that can be interacted with by a user. Example elements such as dropdown menus 354, text fields, and buttons are shown.

Various windows can be used to display data in the GUI. For example, one or more narrative windows 306 can be used to render human-readable text, as shown in 356. For example, one or more data windows 308 can be used to render visual representations of raw data, such as shown in windows 358-362. The layout of the windows 306-308 can be dynamic. For example, the GUI can lay out the windows 306-308 based on the amount of data to be shown, the amount of space available to render the data, etc.

As shown, the GUI can be used to render a newsfeed object such that i) a GUI report and ii) a narrative object are both displayed to a user concurrently. For example the GUI report can be shown in the windows 358-362, while a narrative object can be shown in the window 356.

This rendering can include dynamically generating a number of data-windows (e.g., three windows, windows 358-362) based on a count of a number of types of the information derived from the given data object (e.g., three, for option volume, real context, and intraday volume) such that each type is rendered in a single data-window concurrently.

This rendering can include rendering an interface that that, when interacted with by a user, causes the rendered newsfeed to change a graphical depiction of the information while concurrently displaying the narrative object. For example, a user can select a different dropdown entry in the dropdown box 354 (e.g., Market Overview) and one or more of the data windows (e.g., data window 358) can be changed to a different data rendering (e.g., an overview of market conditions). When the user requests this change, and when the GUI is updating, the human-readable text in window 356 can continue to be shown.

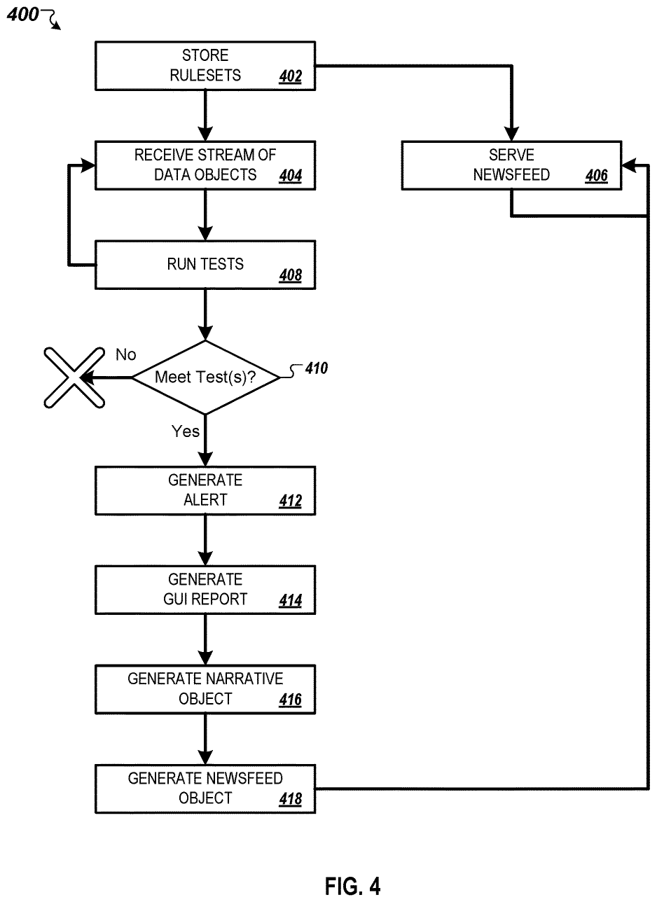

FIG. 4 is an example process 400 for generating natural-language reports from raw data. For example, the process 400 can be used by the exchange computer system 110, the exchange computer system 200, and/or other systems for the automated synthesis of natural-language reports. Therefore, for ease of comprehension, the following description will use the exchange computer system 200 as the basis of explanation.

One or more rulesets are stored 402. For example, in an alert-datastore (e.g., report engine data 210), a plurality of rulesets that each define one or more tests that, when met by one or more data objects, cause an alert to be generated. For example, a user or users can submit, to the exchange computer system 200 one or more rules that define tests such as market conditions, trade parameters, etc. These test can be stored in machine-readable format in the report engine logic 212 such that the report engine processor 208 can run the tests as part of execution of software.

A stream of data objects are received 404. For example, the exchange computer system can store data in the stock market data storage 204, receive data from the network 214, etc. These data objects can be organized into a datastream for the report engine 236 and stored in the report engine data 210.

The data objects of the datastream can include records of exchange operations performed by the exchange computer system 200, and by other exchanges. In some cases, each trade on an exchange can be used to create a corresponding data object. In some cases, multiple trades can be grouped and/or aggregated into a single data object.

A newsfeed is served 406. For example, the report engine 236 can provide one or more newsfeed to user devices through the network 214. In some cases, serving the newsfeed stream can include providing new newsfeed object in a sequential position with other newsfeed objects of the newsfeed stream. In such cases, the user may be able to access newsfeed items in chronological order. In some cases, serving the newsfeed stream can include providing new newsfeed object in an order defined by a query from the user device, such as ordered by sentiment (positive to negative or negative to positive), based on the volume of trades being reported, based on geographic distance from the user device (e.g., local news first), or another ordering.

Tests are run 408. For example, the report engine 236 can apply each rule to each newly created data object to determine if at least one given data objects satisfies the one or more tests of at least one given ruleset. When a test is passed, this indicates that at least one user is interested in this data object, and a newsfeed object should be created for serving in a newsfeed. Regardless of the result of the tests, more data objects continue to be received and tested by the report engine 236.

If a test is met 410, an alert is generated 412. For example, the report engine 236 can create a corresponding alert that includes information derived from the given data object. This can include creating one or more data objects in the report engine data 210, which the report engine 236 can populate

A GUI report is generated 414. For example, the report engine 236 can generate a GUI report that comprises a graphical depiction of the information derived from the given data object. Example GUI reports are shown in the data windows 358-362

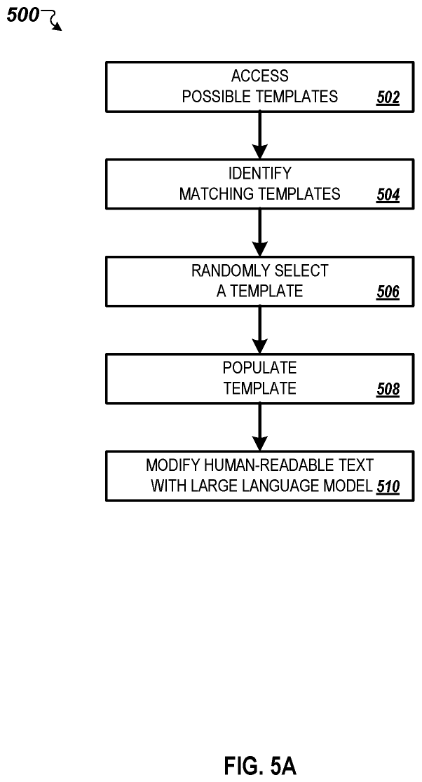

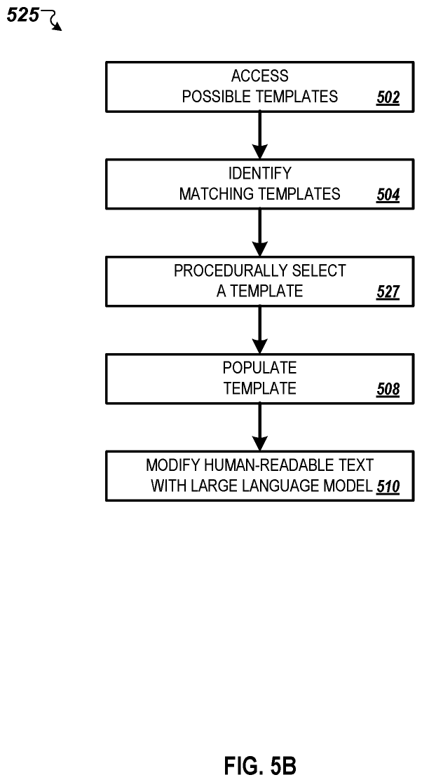

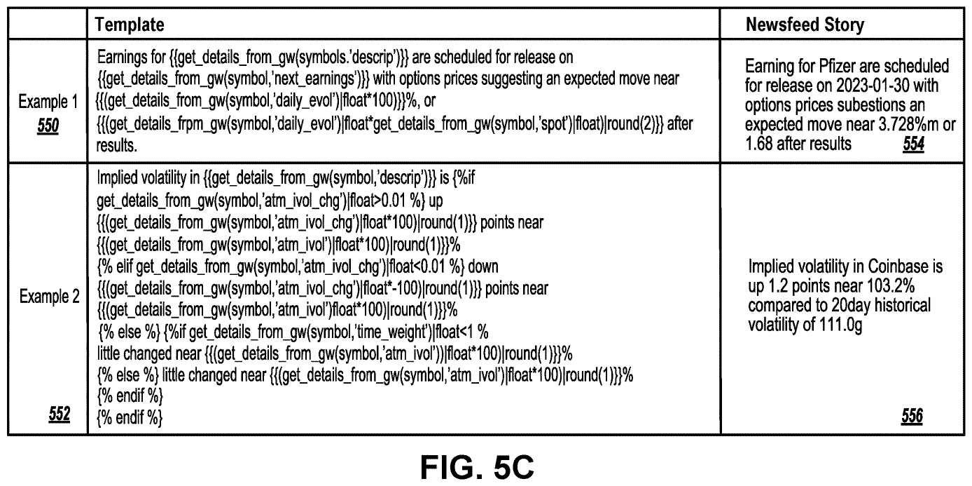

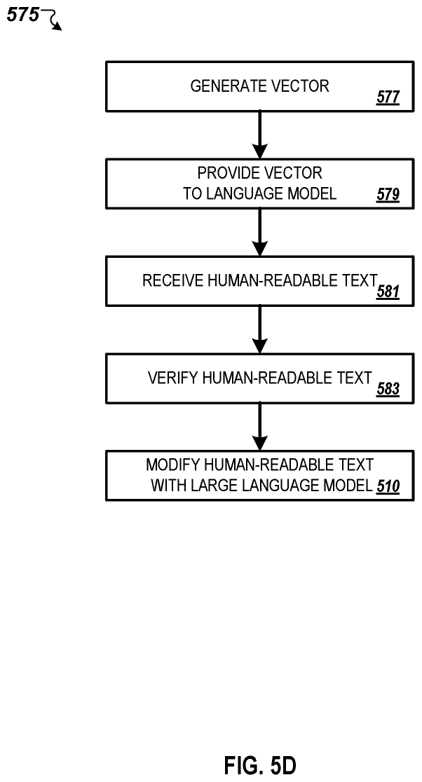

A narrative object is generated 416. For example, the report engine 236 can generate a narrative object using the information derived from the given data object, the narrative object comprising human-readable text, the generating being performed by automated operation of the computer system without specific input from a user. Examples of the generation of the narrative objects are described later with respect to FIG. 5.

A newsfeed object is generated 418. For example, the report engine 236 can collect the GUI report and the narrative object into a single newsfeed object and store the new newsfeed object in the report engine data 210. The report engine 236 can then update one or more newsfeeds being served 406 to include the new newsfeed object.

FIG. 5 is example processes 500, 525 and 575, and data 550, for generating human-readable text. For example, the processes 500, 525, and/or 575 can be used in generating 416 narrative objects. In the process 500, a random template is used to generate the narrative object. This may be preferable, for example, when producing unpredictable narrative objects are desired to increase novelty and freshness, making the user more likely to read the narrative object closely. In the process 525, the oldest template is selected. This may be preferable, for example, when minimizing repetition is desired. In the process 575, a large language model is used to convert a data vector into human-readable language. This may be preferable, for example, when unpredictable market operations are encountered and not template is found to be a good fit for the associated data.

In the process 500, possible templates are accessed 502 and matching templates are identified 504. For example, the report engine 236 can provide the language engine 242 with the data object. The language engine 242 can then access a collection of all templates (e.g., all templates for at least one given user, for at least one given entity, or all templates stored). Each template that matches the data object can be identified for potential selection. For example, if the data object includes five types of information, the language engine 242 can search for all possible templates that have a field for each of the five types of information.

A template is randomly selected 506. For example, the language engine 242 can select one of the possible templates according to a truly random or pseudorandom process. In some cases, the process is unweighted, and each possible template has an even chance of being selected. In some cases, the process is weighted, and each possible template has assigned a selection weight that indicates relative likelihood of selection compared to other possible templates.

The template is populated 508. For example, the language engine 242 can populate each empty field of the selected template with data from the data object. In some cases, the data object may not have sufficient or complete data for the template. In these cases, the language engine can request additional information from the report engine 236. The report engine can determine if it can respond with data from the report engine data 210, and respond with this data if possible. The report engine can request the data from the stock market data storage 204 or an external source over the network 214 if it is not able to respond directly.

Human-readable text is modified with a large language model 510. For example, the language engine 242 can include a large language model, or have network connection to a large language mode via the network 214. The language engine 242 can request that the large language model modify the human-readable text in one or more ways. One example modification is to increase the entropy of the text. This can cause the large language model to reword the human-readable text into another, generally equivalent, text that has generally the same information, but presented in a different way. One example modification is to apply a particular sentiment to the text. For example, the language engin 242 can use data that is indicative of overall market conditions or a particular user's financial situation. When conditions are good (e.g., values going up), a positive sentiment can be applied to the human-readable text. When conditions are bad (e.g., unemployment numbers are increasing), a restrained sentiment can be applied. This kind of sentiment modification can produce human-readable text that is more in line with the likely feelings of the user. Even if the news is good, a user with many unemployed friends may not wish to read the good news in gushing or optimistic text.

In the process 525, possible templates are accessed 502 and matching templates are identified 504. A template is procedurally selected 5027. For example, the language engine 242 may use one or more pre-stored algorithms to select a template. In one example, the language engine 242 may tag each template with various key words (e.g., “automotive” and “garment industry”). Then, when a data object is received, matches between the data object and the key works can be used to find well-matching templates for the data object. In one example, the language engine 242 may maintain a record of the order of templates that are accessed. Then, when it is time to select a new template, the oldest qualifying template is selected.

The template is populated 508 and human-readable text is modified with a large language model 510.

FIG. 5C shows two example templates (“Example 1” 550 and “Example 2” 552). As shown, each example template 550 and 552 is stored as computer-readable code that includes instructions for replacing fields with data from a data object. Examples of human-readable text 554 and 556 are shown, created with example data objects.

In the process 575, a vector is generated 552 and provided to a large language model. For example, the report engine can generate a vector using the information from at least one given data object. For example, the language engine 242 can project the dat object into at least one given vector space. This vector space can include dimensions for all the data from the data object, or only a subset of the data from the data object. In some instances, the vector is a vector of [key, value] pairs that define a type of data (the key) and a data point of the defined type (the value). However, other formats are possible. The language engine 242 can then provide that vector to the large language model.

Human readable text is received 583 and is verified 583. For example, the language engine 242 can receive back a candidate huma-readable text. To verify that the large language model did not introduce any factual errors (sometimes call a hallucination), the language engine 242 can validate the human-readable text. For example, the language engine 242 can project the human-readable text into the same vector space as the data object was projected into to create a verification vector. If the verification vector matches the original vector, the human-readable content can be verified, and rejected if there is no match. As will be appreciated, the match can be a test of perfect correspondences that only passes if the two vector are exactly the same, a distance test that will pass the verification vector is similar enough to the original vector according to a vector-distance calculation, etc.

Human-readable text is modified with a large language model 510.

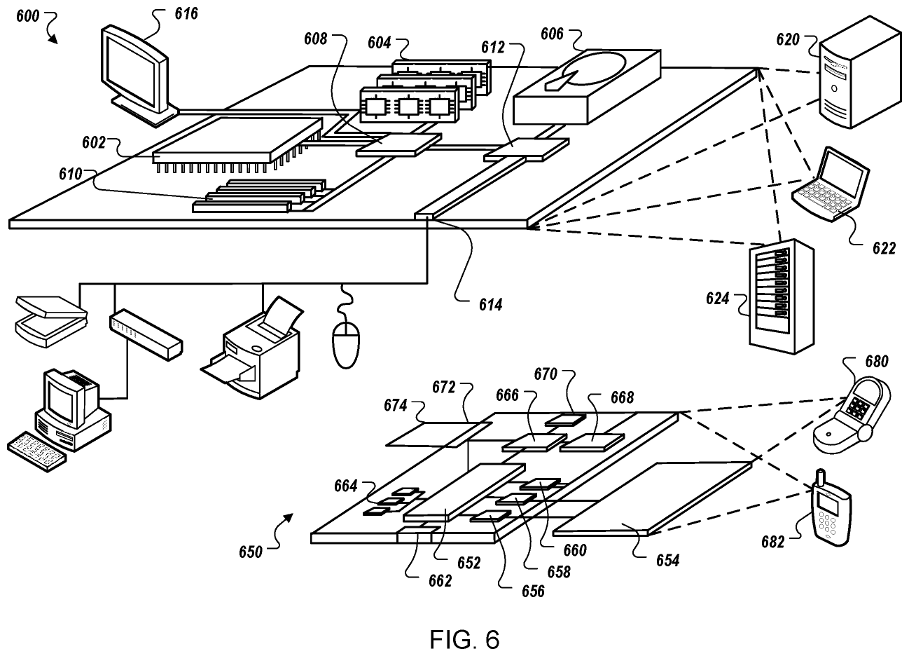

FIG. 6 is a schematic diagram illustrating an example of a computing system used in an exchange computer system. The computing system includes computing device 600 and a mobile computing device 650 that can be used to implement the techniques described herein. For example, one or more components of the exchange computer system 110 be an example of the computing device 600 or the mobile computing device 650.

The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various buses, and can be mounted on a common motherboard or in other manners as appropriate. The processor 602 can process instructions for execution within the computing device 600, including instructions stored in the memory 604 or on the storage device 606 to display graphical information for a Graphical User Interface (GUI) on an external input/output device, such as a display 616 coupled to the high-speed interface 608. In other implementations, multiple processors and/or multiple buses can be used, as appropriate, along with multiple memories and types of memory. In addition, multiple computing devices can be connected, with each device providing portions of the operations (e.g., as a server bank, a group of blade servers, or a multi-processor system). In some implementations, the processor 602 is a single threaded processor. In some implementations, the processor 602 is a multi-threaded processor. In some implementations, the processor 602 is a quantum computer.

The memory 604 stores information within the computing device 600. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the computing device 600. In some implementations, the storage device 606 can be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602). The high-speed interface 608 manages bandwidth-intensive operations for the computing device 600, while the low-speed interface 612 manages lower bandwidth-intensive operations. Such allocation of functions is an example only. In some implementations, the high speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may include one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (nonvolatile random access memory). In some implementations, instructions are stored in an information carrier such that the instructions, when executed by one or more processing devices (e.g., processor 652), perform one or more methods, such as those described above. The instructions can also be stored by one or more storage devices, such as one or more computer or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry in some cases. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 3G/4G cellular, among others. Such communication may occur, for example, through the transceiver 668 using a radio frequency. In addition, short-range communication may occur, such as using a Bluetooth, Wi-Fi, or other such transceiver (not shown). In addition, a GPS (Global Positioning System) receiver module 670 may provide additional navigation-and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, among others) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Implementations have been described, but other implementations are within the scope of the following claims.

A number of implementations have been described hereinabove. It should however be understood that various modifications may be made without departing from the spirit and scope of the disclosure. For example, various forms of the flows shown above may be used, with steps re-ordered, added, or removed. Accordingly, other implementations are within the scope of the disclosure and claims.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. For example, in some implementations of FIG. 4, step 440 may be performed before or at the same time as step 450. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A system for providing natural-language reports from raw data, the system comprising:
a computer system comprising at least one processor and memory, the computer system configured to perform operations comprising:
storing, in an alert-datastore, a plurality of rulesets that each define one or more tests that, when met by one or more data objects, cause an alert to be generated;
receiving a stream of data objects that each record information of an event;
determining that at least one given data objects satisfy the one or more tests of at least one given ruleset and responsively:
generating a corresponding alert that includes information derived from the given data object;
generating a graphic user interface (GUI) report that comprises a graphical depiction of the information derived from the given data object;
generating a narrative object using the information derived from the given data object, the narrative object comprising human-readable text, the generating being performed by automated operation of the computer system without specific input from a user; and
adding, to a newsfeed stream, a new newsfeed object that comprises the GUI report and also comprises the narrative object; and
serving the newsfeed stream comprising providing the new newsfeed object in a sequential position with other newsfeed objects of the newsfeed stream such that the new newsfeed object can be rendered on a client device.

2. The system of claim 1, wherein the operations further comprise:
performing exchange operations, comprising:
executing trades; and
generating, using the executing trades, the stream of data objects, wherein each data object records information of at least one of the executing trades.

3. The system of claim 1, wherein generating the narrative object using the information derived from the given data object comprises randomly selecting a selected template from a plurality of possible templates, and to populate the selected template with the information derived from the given data object.

4. The system of claim 1, wherein generating the narrative object using the information derived from the given data object comprises procedurally selecting a selected template from a plurality of possible templates based on a record of previously-accessed possible templates, and to populate the selected template with the information derived from the given data object.

5. The system of claim 1, wherein generating the narrative object using the information derived from the given data object comprises:
generating a vector using the information derived from the given data object;
providing the vector to a large language model; and
receiving from the large language model the human-readable text.

6. The system of claim 5, wherein generating the narrative object using the information derived from the given data object comprises validating the human-readable text to verify that the generation of the human-readable text by the large language model did not introduce errors in the human-readable text.

7. The system of claim 5, wherein generating the narrative object using the information derived from the given data object comprises modifying the human-readable text with the large language model to modify the human-readable text while maintaining the information derived from the given data object in the human-readable text.

8. The system of claim 1, wherein generating the narrative object using the information comprises:
populating a selected template with the information derived from the given data object; and
modifying the human-readable text with a large language model to modify the human-readable text while maintaining the information derived from the given data object in the human-readable text.

9. The system of claim 1, wherein the operations further comprise rendering the new newsfeed object such that i) the GUI report and ii) the narrative object are both displayed to a user concurrently.

10. The system of claim 9, wherein rendering the new newsfeed object comprises dynamically generating a number of data-windows based on a count of a number of types of the information derived from the given data object such that each type is rendered in a single data-window concurrently.

11. The system of claim 9, wherein rendering the new newsfeed object comprises rendering an interface that that, when interacted with by a user, causes the rendered newsfeed to change a graphical depiction of the information while concurrently displaying the narrative object.

12. A method of automated synthesis of natural-language reports from raw data, the method comprising:
a computer system comprising at least one processor and memory, the computer system configured to perform operations comprising:
storing, in an alert-datastore, a plurality of rulesets that each define one or more tests that, when met by one or more data objects, cause an alert to be generated;
receiving a stream of data objects that each record information of an event;
determining that at least one given data objects satisfies the one or more tests of at least one given ruleset and responsively:
generating a corresponding alert that includes information derived from the given data object;
generating a graphic user interface (GUI) report that comprises a graphical depiction of the information derived from the given data object;
generating a narrative object using the information derived from the given data object, the narrative object comprising human-readable text, the generating being performed by automated operation without specific input from a user; and
adding, to a newsfeed stream, a new newsfeed object that comprises the GUI report and also comprises the narrative object; and
serving the newsfeed stream comprising providing the new newsfeed object in a sequential position with other newsfeed objects of the newsfeed stream.

13. The method of claim 12, wherein generating the narrative object using the information derived from the given data object comprises randomly selecting a selected template from a plurality of possible templates, and to populate the selected template with the information derived from the given data object.

14. The method of claim 12, wherein generating the narrative object using the information derived from the given data object comprises procedurally selecting a selected template from a plurality of possible templates based on a record of previously-accessed possible templates, and to populate the selected template with the information derived from the given data object.

15. The method of claim 12, wherein generating the narrative object using the information derived from the given data object comprises:
generating a vector using the information derived from the given data object;
providing the vector to a large language model; and
receiving from the large language model the human-readable text.

16. The method of claim 15, wherein generating the narrative object using the information derived from the given data object comprises validating the human-readable text to verify that the generation of the human-readable text by the large language model did not introduce errors in the human-readable text.

17. The method of claim 12, wherein the operations further comprise rendering the new newsfeed object such that i) the GUI report and ii) the narrative object are both displayed to a user concurrently.

18. The method of claim 17, wherein rendering the new newsfeed object comprises dynamically generating a number of data-windows based on a count of a number of types of the information derived from the given data object such that each type is rendered in a single data-window concurrently.

19. The method of claim 17, wherein rendering the new newsfeed object comprises rendering an interface element that, when interacted with by a user, causes the rendered newsfeed to change a graphical depiction of the information while concurrently displaying the narrative object.

20. A non-transitory computer-readable medium storing instructions that, when executed by one or more processors, cause the one or more processors to perform operations comprising:
storing, in an alert-datastore, a plurality of rulesets that each define one or more tests that, when met by one or more data objects, cause an alert to be generated;
receiving a stream of data objects that each record information of an event;
determining that at least one given data object satisfies the one or more tests of at least one given ruleset and responsively:
generating a corresponding alert that includes information derived from the given data object;
generating a graphic user interface (GUI) report that comprises a graphical depiction of the information derived from the given data object;
generating a narrative object using the information derived from the given data object, the narrative object comprising human-readable text, the generating being performed by automated operation without specific input from a user; and
adding, to a newsfeed stream, a new newsfeed object that comprises the GUI report and also comprises the narrative object; and
serving the newsfeed stream comprising providing the new newsfeed object in a sequential position with other newsfeed objects of the newsfeed stream.
